(19) United States
(12) Patent Application Publication
(10) Pub. No.: US 2008/0162125 A1
(43) Pub. Date: Jul. 3, 2008

(54) METHOD AND APPARATUS FOR LANGUAGE INDEPENDENT VOICE INDEXING AND SEARCHING

(75) Inventors: Changxue C. Ma, Barrington, IL (US); Feipeng Li, Urbana, IL (US)

Correspondence Address: PRASS & IRVING LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/617,265

(22) Filed: Dec. 28, 2006

(51) Int. Cl. G10L 19/12

(52) U.S. Cl. 704/222; 704/E15.004

(57) ABSTRACT

A method and apparatus for language independent voice searching in a mobile communication device is disclosed. The method may include receiving a search query from a user of the mobile communication device, converting speech parts in the search query into linguistic representations which covers at least one languages, generating a search phoneme lattice based on the linguistic representations, extracting query features from the search phoneme lattice, generating query feature vectors based on the extracted features, performing a coarse search using the query feature vectors and the indexing feature vectors from the indexing database, performing a fine search using the results of the coarse search and the indexing phoneme lattices stored in the indexing database, and outputting the fine search results to a dialog manager.

### BACKGROUND OF THE INVENTION

1. Field of the Invention

The invention relates to mobile communication devices, and in particular, to voice indexing and searching in mobile communication devices.

2. Introduction

Mobile communication devices such as cellular phones are very pervasive communication devices used by people of all languages. The usage of the devices has expanded far beyond pure voice communication. User is able now to use the mobile communication devices as voice recorders to record notes, conversations, messages, etc. User can also annotate contents such as photos, videos and applications on the device with voices.

While these capabilities have been expanded, the ability to search for the stored audio contents on the mobile communication device is limited. Due to the difficulty of navigating the contents with buttons, mobile communication device users may find it useful to be able to quickly find voice annotated contents, stored voice-recorded conversations, notes and messages.

### SUMMARY OF THE INVENTION

A method and apparatus for language independent voice indexing and searching in a mobile communication device is disclosed. The method may include receiving a search query from a user of the mobile communication device, converting speech parts in the search query into linguistic representations, generating a search phoneme lattice based on the linguistic representations, extracting query features from the search phoneme lattice, generating query feature vectors based on the extracted features, performing a coarse search using the query feature vectors and the indexing feature vectors from the indexing database, performing a fine search using the results of the coarse search and the indexing phoneme lattices stored in the indexing database, and outputting the fine search results to a dialog manager.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary diagram of a mobile communication device in accordance with a possible embodiment of the invention;

FIG. 2 illustrates a block diagram of an exemplary mobile communication device in accordance with a possible embodiment of the invention;

FIG. 3 illustrates an exemplary block diagram of the indexing and voice search engines in accordance with a possible embodiment of the invention; and

FIG. 4 is an exemplary flowchart illustrating one possible voice search process in accordance with one possible embodiment of the invention.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The invention comprises a variety of embodiments, such as a method and apparatus and other embodiments that relate to the basic concepts of the invention.

This invention concerns a language independent indexing and search process that can be used for the fast retrieval of voice annotated contents and voice messages on mobile devices. The voice annotations or voice messages may be converted into phoneme lattices and indexed by unigram and bigram feature vectors automatically extracted from the voice annotations or voice messages. The voice messages or annotations are segmented and each audio segment may be represented by a modulated feature vector whose components are unigram and bigram statistics of the phoneme lattice. The unigram statistics can be phoneme frequency counts of the phoneme lattice. The bigram statistics can be the frequency counts of two consecutive phonemes. The search process may involve two stages: a coarse search that looks up the index and quickly returns a set of candidate voice annotations or voice messages; and a fine search then compares the best path of the query voice to the phoneme lattices of the candidate annotations or messages by using dynamic programming.

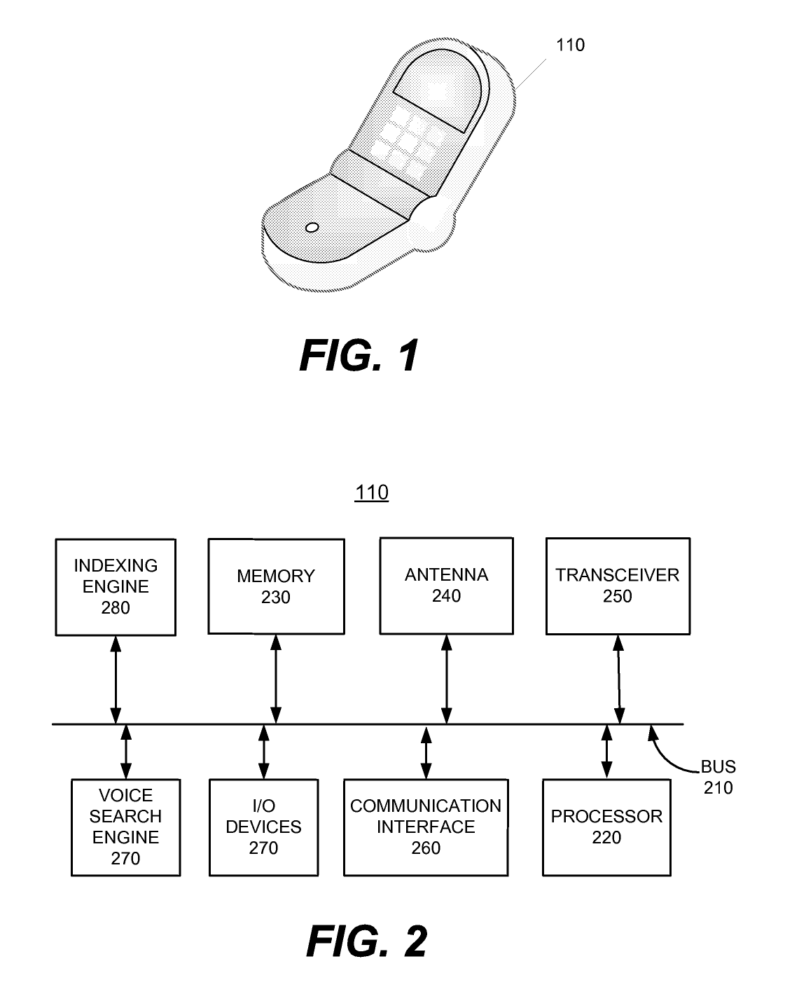

FIG. 1 illustrates an exemplary diagram of a mobile communication device 110 in accordance with a possible embodiment of the invention. While FIG. 1 shows the mobile communication device 110 as a wireless telephone, the mobile communication device 110 may represent any mobile or portable device having the ability to internally or externally record and or store audio, including a mobile telephone, cellular telephone, a wireless radio, a portable computer, a laptop, an MP3 player, satellite radio, satellite television, Digital Video Recorder (DVR), television set-top box, etc.

FIG. 2 illustrates a block diagram of an exemplary mobile communication device 110 having a voice search engine 270 in accordance with a possible embodiment of the invention. The exemplary mobile communication device 110 may include a bus 210, a processor 220, a memory 230, an antenna 240, a transceiver 250, a communication interface 260, voice search engine 270, indexing engine 280, and input/output (I/O) devices 290. Bus 210 may permit communication among the components of the mobile communication device 110.

Processor 220 may include at least one conventional processor or microprocessor that interprets and executes instructions. Memory 230 may be a random access memory (RAM) or another type of dynamic storage device that stores information and instructions for execution by processor 220. Memory 230 may also include a read-only memory (ROM) which may include a conventional ROM device or another type of static storage device that stores static information and instructions for processor 220.

Transceiver 250 may include one or more transmitters and receivers. The transceiver 250 may include sufficient functionality to interface with any network or communication station and may be defined by hardware or software in any manner known to one of skill in the art. The processor 220 is cooperatively operable with the transceiver 250 to support operations within the communications network.

Input/output devices (I/O devices) 290 may include one or more conventional input mechanisms that permit a user to input information to the mobile communication device 110, such as a microphone, touchpad, keypad, keyboard, mouse, pen, stylus, voice recognition device, buttons, etc. Output devices may include one or more conventional mechanisms that outputs information to the user, including a display, printer, one or more speakers, a storage medium, such as a memory, magnetic or optical disk, and disk drive, etc., and/or interfaces for the above.

Communication interface 260 may include any mechanism that facilitates communication via the communications network. For example, communication interface 260 may include a modem. Alternatively, communication interface 260 may include other mechanisms for assisting the transceiver 250 in communicating with other devices and/or systems via wireless connections.

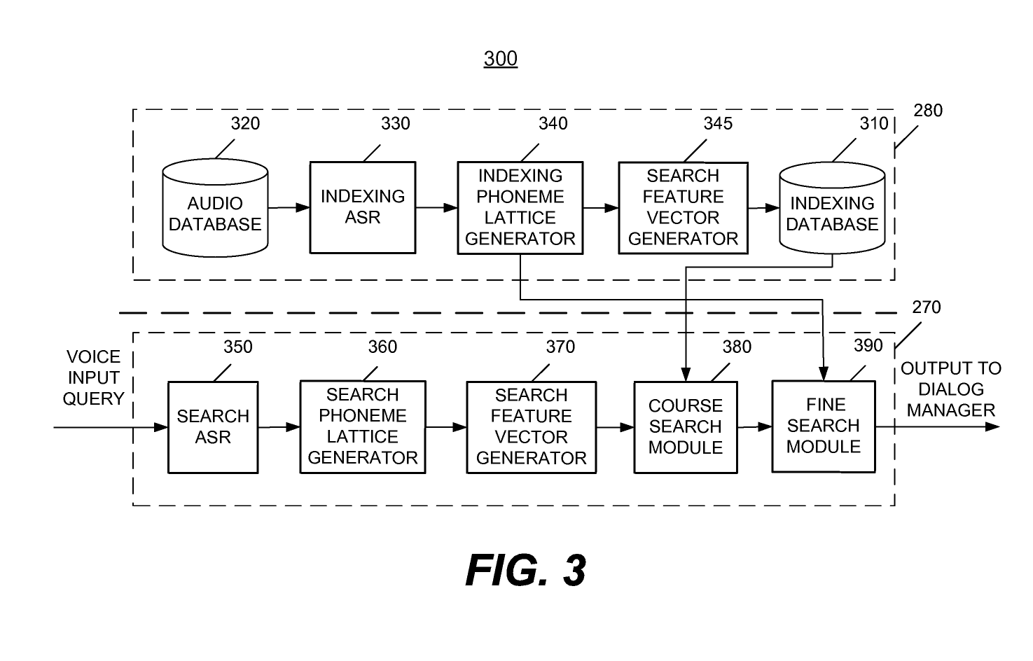

The functions of the voice search engine 270 and the indexing engine 280 will be discussed below in relation to FIG. 3 in greater detail.

The mobile communication device 110 may perform such functions in response to processor 220 by executing sequences of instructions contained in a computer-readable medium, such as, for example, memory 230. Such instructions may be read into memory 230 from another computer-readable medium, such as a storage device or from a separate device via communication interface 260.

The mobile communication device 110 illustrated in FIGS. 1-2 and the related discussion are intended to provide a brief, general description of a suitable communication and processing environment in which the invention may be implemented. Although not required, the invention will be described, at least in part, in the general context of computer-executable instructions, such as program modules, being executed by the mobile communication device 110, such as a communications server, or general purpose computer. Generally, program modules include routine programs, objects, components, data structures, etc. that perform particular tasks or implement particular abstract data types. Moreover, those skilled in the art will appreciate that other embodiments of the invention may be practiced in communication network environments with many types of communication equipment and computer system configurations, including cellular devices, mobile communication devices, personal computers, hand-held devices, multi-processor systems, microprocessor-based or programmable consumer electronics, and the like.

FIG. 3 illustrates an exemplary block diagram of voice search system 300 having an indexing engine 280 and voice search engine 270 in accordance with a possible embodiment of the invention. Indexing engine 280 may include audio database 320, indexing automatic speech recognizer (ASR) 330, indexing phoneme lattice generator 340, indexing feature vector generator 345, and indexing database 310. Voice search engine 270 may include search ASR 350, search phoneme lattice generator 360, search feature vector generator 370, coarse search module 380, and fine search module 390.

In the indexing engine 280, the audio database 320 may contain audio recordings such as voice mails, conversations, notes, messages, annotations, etc. which are input to an indexing ASR 330. The indexing ASR 330 may recognize the input audio and may present the recognition results.

The recognition results may be in the form of universal linguistic representations which cover the languages that the user of the mobile communication device chooses. For examples, a Chinese user may choose Chinese and English as the languages for the communication devices. An American user may choose English and Spanish as the languages used for the devices. In any event, the user may choose at least one language to use. The universal linguistic representations may include phoneme representations, syllabic representations, morpheme representations, word representations, etc.

The linguistic representations are then input into an indexing phoneme lattice generator 340. The indexing phoneme lattice generator 340 generates a lattice of linguistic representations, such as phonemes, representing the speech stream. A lattice consists of a series of connected nodes and edges. Each edge may represent a phoneme with a score being the log of the probability of the hypothesis. The nodes on the two ends of each edge denote the start time and end time of the phoneme. Multiple edges (hypothesis) may occur between two nodes and the most probable path from the start to the end is called “the best path”.

The indexing feature vector generator 345 extracts index terms or “features” from the generated phoneme lattices. These features may be extracted according to their probabilities (correctness), for example. The indexing feature vector generator 345 then maps each of the extracted index terms (features) to the phoneme lattices where the feature appears and stores the resulting vectors in the indexing database 310.

The indexing database 310 stores phoneme lattices, feature vectors and indices for all audio recordings, messages, features, functions, files, content, events, etc. in the mobile communication device 110. As audio recordings are added to and/or stored in the mobile communication device 110, they may be processed and indexed according to the above-described process.

For illustrative purposes, the voice search engine 270 and its corresponding process will be described below in relation to the block diagrams shown in FIGS. 1-3.

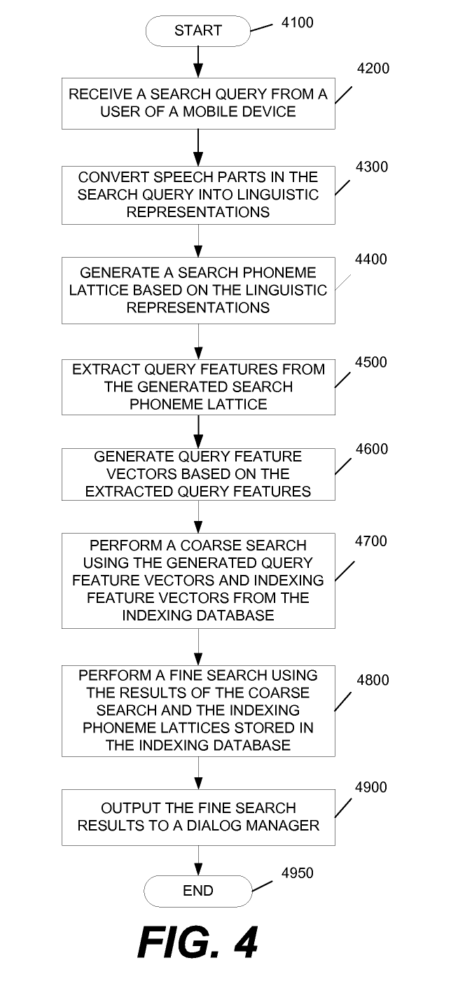

FIG. 4 is an exemplary flowchart illustrating one possible voice search process in accordance with one possible embodiment of the invention. The process begins at step 4100 and continues to step 4200 where the voice search engine 270 receives a search query from the user of the mobile communication device 110. At step 4300, the search ASR 350 of the voice search engine 270 converts speech parts in the search query into linguistic representations. At step 4400, the search phoneme lattice generator 360 generates a search phoneme lattice based on the linguistic representations.

At step 4500, the search feature vector generator 370 extracts query features from the generated search phoneme lattice. At step 4600, the search feature vector generator 370 generates query feature vectors based on the extracted query features so that the search query has the same representation form as the indexing phoneme lattice and indexing feature vectors stored in the indexing database 310.

At step 4700, the coarse search module 380 performs a coarse search using the query feature vectors and the indexing feature vectors from the indexing database 310. For a given search query, the coarse search module 380 first computes the cosine distances between the query feature vector and the indexing feature vectors of all the indexed audio files, such as messages, for example, in the indexing database 310 and ranks the messages according to magnitude of the cosine distances. A set of top candidate messages, usually 4 to 5 times the amount of the final search results, will be returned for detailed search. In practice, the coarse search module 380 may optimize the process by sorting the messages in a tree structure so that computation can be further reduced for the matching between the search query and the target audio messages.

At step 4800, the fine search module 390 performs a fine search using the results of the coarse search and the indexing phoneme lattices stored in the indexing database 310. The fine search makes an accurate comparison between search query best path and the phoneme lattices of the candidate messages from the indexing database 310.

In order to save computational costs, the fine search module 390 classifies query messages into long and short messages according to the length of their best paths. For long messages, a match between the query and the target best paths may be reliable enough despite the high phoneme error rate. Edit distance may be used to measure the similarity between two best paths. For short messages, however, best paths may not be reliable due to the high phoneme error rate, and a thorough match between the query best path and the whole target indexing phoneme lattices is necessary.

At step 4900, the fine search module 390 of the voice search engine 270 outputs the fine search results to a dialogue manager. The dialogue manager may then conduct further interaction with the user. The process goes to step 4500, and ends.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. For example, the principles of the invention may be applied to each individual user where each user may individually deploy such a system. This enables each user to utilize the benefits of the invention even if any one of the large number of possible applications do not need the functionality described herein. In other words, there may be multiple instances of the voice search engine 270 in FIGS. 2-3 each processing the content in various possible ways. It does not necessarily need to be one system used by all end users. Accordingly, the appended claims and their legal equivalents should only define the invention, rather than any specific examples given.

We claim:

1. A method for language independent voice indexing and searching in a mobile communication device, comprising:
receiving a search query from a user of the mobile communication device;
converting speech parts in the search query into linguistic representations;
generating a search phoneme lattice based on the linguistic representations;
extracting query features from the generated search phoneme lattice;
generating query feature vectors based on the extracted query features;
performing a coarse search using the generated query feature vectors and indexing feature vectors from an indexing database, wherein the indexing database stores indices of indexing feature vectors from indexing phoneme lattices of audio files stored on the mobile communication devices;
performing a fine search using the results of the coarse search and the indexing phoneme lattices stored in the indexing database; and
outputting the fine search results to a dialog manager.

2. The method of claim 1, wherein the linguistic representations are at least one of words, morphemes, syllables, and phonemes of at least one language.

3. The method of claim 1, wherein the search query concerns an audio file stored on the mobile communication device.

4. The method of claim 3, wherein the audio file is one of audio recordings, voice mails, recorded conversations, notes, messages, and annotations.

5. The method of claim 1, wherein the coarse search generates a plurality of candidate audio files based on the search query.

6. The method of claim 5, wherein the fine search generates the best candidate out of the coarse search results.

7. The method of claim 1, wherein the mobile communication device is one of a mobile telephone, cellular telephone, a wireless radio, a portable computer, a laptop, an MP3 player, satellite radio, satellite television, Digital Video Recorder (DVR), and television set-top box.

8. An apparatus for language independent voice searching in a mobile communication device, comprising:
an indexing database that stores indices of indexing feature vectors from indexing phoneme lattices of audio files stored on the mobile communication devices; and
a voice search engine that receives a search query from a user of the mobile communication device, converts speech parts in the search query into linguistic representations, generates a search phoneme lattice based on the linguistic representations, extracts query features from the generated search phoneme lattice, generates query feature vectors based on the extracted query features, performs a coarse search using the query feature vectors and indexing feature vectors from the indexing database, performs a fine search using the results of the coarse search and the indexing phoneme lattices stored in the indexing database, and outputs the fine search results to a dialog manager.

9. The apparatus of claim 8, wherein the linguistic representations are at least one of words, morphemes, syllables, and phonemes of at least one language.

10. The apparatus of claim 8, wherein the search query concerns an audio file stored on the mobile communication device.

11. The apparatus of claim 10, wherein the audio file is one of audio recordings, voice mails, recorded conversations, notes, messages, and annotations.

12. The apparatus of claim 8, wherein the coarse search performed by the voice search engine generates a plurality of candidate audio files based on the search query.

13. The apparatus of claim 12, wherein the fine search performed by the voice search engine generates the best candidate out of the coarse search results.

14. The apparatus of claim 8, wherein the mobile communication device is one of a mobile telephone, cellular telephone, a wireless radio, a portable computer, a laptop, an MP3 player, satellite radio, satellite television, Digital Video Recorder (DVR), and television set-top box.

15. An apparatus for language independent voice searching in a mobile communication device, comprising:
an indexing database that stores indices of indexing feature vectors from indexing phoneme lattices of audio files stored on the mobile communication device;
a search automatic speech recognizer that receives a search query from a user of the mobile communication device and converts speech parts in the search query into linguistic representations;
a search phoneme lattice generator that generates a search phoneme lattice based on the linguistic representations;
a search feature vector generator that extracts query features from the search phoneme lattice and generates query feature vectors based on the extracted query features;
a coarse search module that performs a coarse search using the query feature vectors and indexing feature vectors from the indexing database; and
a fine search module that performs a fine search using the results of the coarse search and the indexing phoneme lattices stored in the indexing database, and outputs the fine search results to a dialog manager.

16. The apparatus of claim 15, wherein the linguistic representations are at least one of words, morphemes, syllables, and phonemes of at least one language.

17. The apparatus of claim 15, wherein the search query concerns an audio file stored on the mobile communication device.

18. The apparatus of claim 17, wherein the audio file is one of audio recordings, voice mails, recorded conversations, notes, messages, and annotations.

19. The apparatus of claim 15, wherein the coarse search module generates a plurality of candidate audio files based on the search query, and the fine search module generates the best candidate out of the coarse search results.

20. The apparatus of claim 15, wherein the mobile communication device is one of a mobile telephone, cellular telephone, a wireless radio, a portable computer, a laptop, an MP3 player, satellite radio, satellite television, Digital Video Recorder (DVR), and television set-top box.
